(19) United States
(12) Patent Application Publication
(10) Pub. No.: US 2024/0125607 A1
(43) Pub. Date: Apr. 18, 2024

(54) TRANSPORTATION MANAGEMENT AND BATTERY CHARGE MANAGEMENT SERVER FOR TRANSPORTATION ELECTRIC VEHICLE AND CONTROLLING METHOD THEREOF

(71) Applicant: KKUN, Jeollabuk-do (KR)

(72) Inventors: Byeong Chan SIM, Seoul (KR); Seok Su HAN, Seoul (KR)

(21) Appl. No.: 18/369,950

(22) Filed: Sep. 19, 2023

(30) Foreign Application Priority Data
Oct. 14, 2022 (KR) 10-2022-0132011

(51) Int. Cl. G01C 21/34; B60L 53/62; B60L 58/12

(52) U.S. Cl. CPC G01C 21/3469; B60L 53/62; B60L 58/12; B60L 2240/64

(57) ABSTRACT

A battery charge management server for an electric vehicle may include a storage unit configured to store and update transportation data, a communication unit configured to receive information on a destination and information on an electric vehicle battery from a user, and a processor configured to calculate a driving route and a transportation time to the destination based on the transportation data and the information on the destination, predict a remaining battery capacity of the electric vehicle battery after reaching the destination based on the driving route, the transportation time, and the electric vehicle battery, and providing the predicted remaining battery capacity.

### PRIORITY

This application claims the benefit under 35 USC § 119 of Korean Patent Application No. 10-2022-0132011, filed on Oct. 14, 2022, in the Korean Intellectual Property Office, the entire disclosure of which is incorporated herein by reference for all purposes.

### BACKGROUND

### 1. Field of the Invention

The present disclosure relates to a transportation management and battery charge management server for transportation electric vehicles and a controlling method thereof, and more particularly, to a transportation management and battery charge management server for transportation electric vehicles and a controlling method thereof for predicting remaining battery capacity.

### 2. Description of the Related Art

Recently, electric vehicles have become prevalent due to the development of battery technology, eco-friendly policies, and the government's active recommendation policies. Also, electric vehicles have not only been used as personal vehicles but also expanded to business purposes, such as vehicles for transportation for cargo or people. However, due to insufficient battery life and infrastructure facilities, such as charging stations, user convenience and usability have not been improved when using electric vehicles for business purposes, causing inconvenience in operating electric vehicles for transportation.

In addition, electric vehicles generally provide information on a distance to empty depending on a current battery charge status, but accuracy thereof may be still low to cause user inconvenience, and the accuracy of information on a remaining battery capacity after driving, as well as a distance to empty, is not still high.

In particular, the amount of battery consumed actually may vary depending on an environment, time zone, and traffic conditions of a road on which the electric vehicle may drive, and in addition, the amount of battery consumption may also vary depending on the weight of a load applied to the electric vehicle.

Additionally, an electric vehicle user may face inconvenience of having to individually find and check a battery charging station considering charging terminal specifications and charging time of the electric vehicle.

As such, due to the low accuracy of information provided from electric vehicles and the difficulty in predicting battery consumption, there are difficulties in battery charging when using electric vehicles for transportation due to the nature of transportation vehicles that are to constantly move around, which therefore, acts as a problem that hinders stable operation.

Accordingly, when using electric vehicles for transportation, the need for services that estimate a remaining battery capacity based on road conditions or provide charging guides based on the estimated remaining battery capacity has increased.

### SUMMARY

An aspect of the present disclosure relates to a transportation management and battery charge management server for transportation electric vehicles and a controlling method thereof and provides a transportation management and battery charge management server for transportation electric vehicles and a controlling method thereof for predicting remaining battery capacity.

According to an aspect of the present disclosure, a battery charge management server for an electric vehicle includes: a storage unit configured to store and update transportation data; a communication unit configured to receive information on a destination and information on an electric vehicle battery from a user; and a processor configured to calculate a driving route and a transportation time to the destination based on the transportation data and the information on the destination, predict a remaining battery capacity of the electric vehicle battery after reaching the destination based on the driving route, the transportation time, and the information on the electric vehicle battery, and providing the predicted remaining battery capacity.

The transportation data may include regional and hourly data and road information based on actual driving records, the regional and hourly data may include hourly driving record data and driving time data within a region, and the road information may include road condition information and traffic information within a region.

The information on the electric vehicle battery may include at least one of a real-time remaining battery capacity of the electric vehicle battery, consumption rate, a charging time, and a distance to empty.

When the remaining battery capacity of the electric vehicle battery predicted in real time is less than a preset remaining battery capacity limit, the processor may select an electric vehicle battery charging station based on whether the vehicle is within a preset distance range based on the calculated driving route and an increase in the transportation time and include a location of the selected electric vehicle battery charging station in the driving route.

When the remaining battery capacity of the electric vehicle battery predicted in real time is less than a preset remaining battery capacity limit, the processor may select an electric vehicle battery charging station based on whether the vehicle is within a preset distance range based on the destination and charging information of the electric vehicle and include a location of the selected electric vehicle battery charging station in the driving route.

The charging information of the electric vehicle may include information on at least one of a type of the electric vehicle, a type of a charging terminal, a charging rate, and a charging time.

The processor may divide the calculated driving route into a first section in which the remaining battery capacity of the electric vehicle battery is greater than the preset remaining battery capacity limit and a second section in which the remaining battery capacity of the electric vehicle battery is less than the preset remaining battery capacity limit and select the electric vehicle battery charging station within the first section.

When the remaining battery capacity of the electric vehicle battery is less than the preset remaining battery capacity limit, the processor may generate and transmit a warning signal.

The communication unit may receive information on a load amount, and the processor may calculate an increase/decrease rate of the load amount based on the information on the load amount, correct the driving route, the transportation time, and the information on the electric vehicle battery based on the calculated increase/decrease rate of the load amount, and predict a remaining battery capacity of the electric vehicle battery based on the corrected driving route, the transportation time, and the information on the electric vehicle battery.

The processor may divide the calculated driving route into a section before a change in the load amount and a section after the change in the load amount, calculate a driving route and a transportation time in the section before the change in the load amount and a driving route and a transportation time in the section after the change in the load amount, and predict the remaining battery capacity of the electric vehicle battery based on the calculated driving route and transportation time in the section before the change in the load amount, the calculated driving route and transportation time in the section after the change in the load amount, and the information on the electric vehicle battery in each of the sections before/after the change in the load amount.

According to another aspect of the present disclosure, a controlling method of a battery charge management server for an electric vehicle includes: storing and updating transportation data; receiving information on a destination and information on an electric vehicle battery from a user; calculating a driving route and a transportation time to the destination based on the transportation data and the information on the destination; and predicting a remaining battery capacity of an electric vehicle battery after reaching the destination based on the driving route, the transportation time, and the information on the electric vehicle battery, and providing the predicted remaining battery capacity of the electric vehicle battery.

According to the various embodiments of the present disclosure as described above, it is possible to accurately predict a remaining battery capacity and set a driving route via an electric vehicle battery charging station, thereby increasing convenience for electric vehicle users.

### BRIEF DESCRIPTION OF THE DRAWINGS

FIG. 1 is a diagram illustrating a configuration of a battery charge management server for an electric vehicle according to an embodiment of the present disclosure.

FIGS. 2A and 2B are diagrams regarding selecting an electric vehicle battery charging station and setting a driving route according to an embodiment of the present disclosure.

FIG. 3 is a diagram illustrating a process of selecting an electric vehicle battery charging station for each section according to a remaining battery capacity of an electric vehicle according to an embodiment of the present disclosure.

FIG. 4 is a diagram illustrating a process of predicting a remaining battery capacity of an electric vehicle for each section according to an increase or decrease in load amount according to an embodiment of the present disclosure.

FIG. 5 is a flowchart illustrating a controlling method of a battery charge management server for an electric vehicle according to an embodiment of the present disclosure.

### DETAILED DESCRIPTION

Hereinafter, various embodiments of the present disclosure will be described in detail with reference to the accompanying drawings. In the following description, if a detailed description of the relevant known functions or configurations is determined to unnecessarily obscure the gist of the present disclosure, the detailed description will be omitted. The terms used henceforth are defined in consideration of the functions of the disclosure and may be altered according to the intent of a user or operator, or conventional practice. Therefore, the terms should be defined on the basis of the entire content of this disclosure.

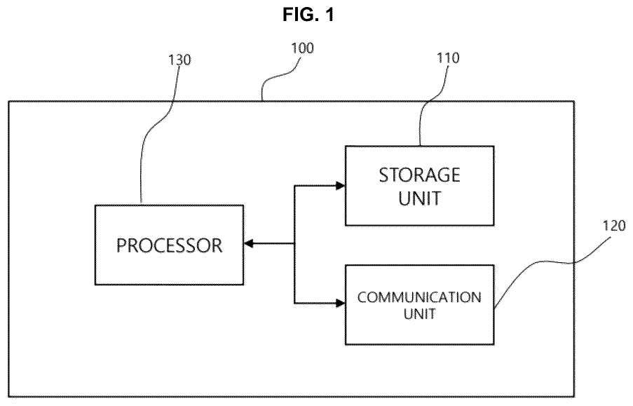

FIG. 1 is a diagram illustrating a configuration of a battery charge management server for an electric vehicle according to an embodiment of the present disclosure.

Referring to FIG. 1, a battery charge management server 100 for an electric vehicle according to an embodiment of the present disclosure includes a storage unit 110, a communication unit 120, and a processor 130. Here, the server 100 refers to a computer program or device as a computer system that provides information or services to clients through a network. In particular, software that operates in a server is called server software, and an algorithm for calculating a driving route and a transportation time to a destination and an algorithm for predicting a remaining battery capacity of an electric vehicle battery according to an embodiment of the present disclosure may be considered an example of server software.

Specifically, the storage unit 110 may store transportation data, and here, the transportation data may include regional and hourly data and road information based on actual driving records, and the regional and hourly data may include hourly driving record data and driving time data within a certain region.

For example, regional and hourly data may be classified into morning driving record data and driving time data, afternoon driving record data and driving time data, evening driving record data and driving time data, etc. from region A to the same destination, and may also be classified into driving record data and driving time data by unit time, such as 9 to 10 o'clock, 10 to 11 o'clock, etc.

In addition, road information may include road condition information and traffic information in a region. For example, road information may include road status information, traffic information, accident information, and construction section information in the region A, classified by time zone.

Also, the storage unit 110 may update and store the aforementioned transportation data in real time.

In addition, the communication unit 120 may receive information on the destination and information on the electric vehicle battery from a user.

For example, when the user inputs a destination in a user terminal device or an electric vehicle, information on the input destination may be received through the communication unit 120, and similarly, information on the electric vehicle battery input or recorded through the user terminal device or the electric vehicle may also be received through the communication unit 120.

In addition, information on the electric vehicle battery may include at least one of a real-time remaining battery capacity of the electric vehicle battery, a consumption rate, a charging time, and a distance to empty. Here, the real-time remaining battery capacity of the electric vehicle battery refers to a remaining battery capacity of the electric vehicle battery per real time, the consumption rate refers to a rate at which the electric vehicle battery decreases, and the distance to empty refers to a distance by which the vehicle may drive according to the remaining battery capacity of the electric vehicle battery.

Meanwhile, the processor 130 may calculate the driving route and the transportation time to the destination based on the transportation data and the information on the destination, and predict a remaining battery capacity of the electric vehicle battery after reaching the destination based on the driving route, the transportation time, and the information on the electric vehicle battery in real time and provide the predicted remaining capacity.

Specifically, the processor 130 may calculate the driving route and the transportation time to the destination based on regional and hourly data based on actual driving records, the road information, and the information on the destination.

For example, the processor 130 may search for regional and hourly data corresponding to a time at which the information on the destination is received through the communication unit 120, and calculate the driving route and the transportation time to the destination according to the searched data.

That is, if the time at which destination A is received through the communication unit 120 is 9:30 a.m., the processor 130 may search for data based on actual driving records in region A′ including a destination A between 9:00 a.m. and 10:00 a.m. by date, derive the most frequent driving route and average transportation time by collecting searched data, and calculate the same as a recommended driving route to destination A and transportation time.

In addition, the processor 130 may predict a remaining battery capacity of the electric vehicle battery after reaching the destination based on information on the driving route, transportation time, and the information on the electric vehicle battery in real time and provide the predicted remaining battery capacity of the electric vehicle battery.

Specifically, the processor 130 may calculate an average consumption amount of the electric vehicle battery predicted based on the calculated transportation time, and additionally, calculate a consumption amount of the battery increased/decreased for each situation based on a road condition, traffic situation, and road surface information, and accident information included in the calculated driving route to the destination, and accordingly, accurately predict a remaining battery capacity of the electric vehicle battery after reaching the destination in real time by adding the average consumption amount of the electric vehicle battery based on the transportation time and the consumption amount of the battery increased/decreased for each situation, and provide the same.

That is, the processor 130 may calculate the driving route and transportation time to the destination at a corresponding time zone by comparing the destination and time zone among data by region and date based on actual driving and searching for the most similar data. A detailed consumption amount of the battery may be predicted based on the calculated driving route, transportation time, and road information, and as a result, a remaining battery capacity of the electric vehicle battery after reaching the destination may be accurately predicted and provided in real time.

Meanwhile, if the remaining battery capacity of the electric vehicle battery is less than a preset remaining battery capacity limit, the processor 130 may select an electric vehicle battery charging station based on whether the vehicle is within a preset distance range based on the calculated driving route and the increase in transportation time, and include a location of the selected electric vehicle battery charging station in the driving route.

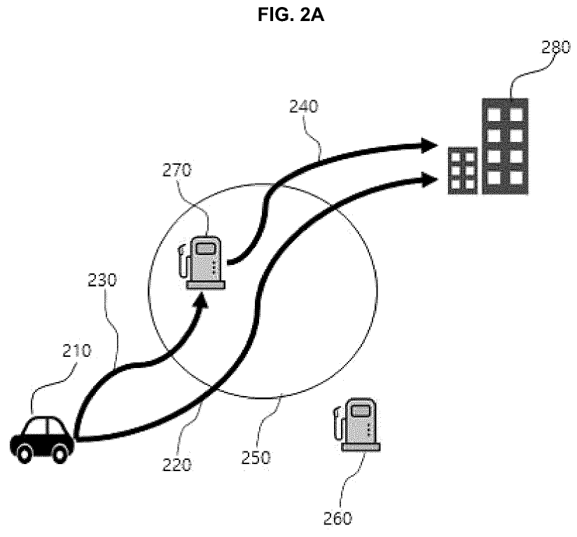

FIGS. 2A and 2B are diagrams of selecting an electric vehicle battery charging station and setting a driving route according to an embodiment of the present disclosure.

Referring to FIG. 2A, when information on a destination 280 is received from the user of an electric vehicle 210 through the communication unit 120 of the battery charge management server 100 for an electric vehicle, the processor 130 may calculate a first driving route 220 and a first transportation time to the destination based on transportation data to the destination 280, that is, hourly data to the destination 280 based on actual driving records, road information, and information on the destination 280.

In addition, if a remaining battery capacity of the electric vehicle battery predicted in real time after the electric vehicle 210 reaches the destination 280 after the first driving route 220 and the first transportation time, the processor 130 may select an electric vehicle battery charging station based on whether the vehicle is within a preset distance range 250 based on the calculated driving route, i.e., the first driving route 220, and an increase in the transportation time.

For example, the processor 130 may not select an electric vehicle battery charging station 260 not included within the preset distance range 250 based on the first driving route 220, but may select an electric vehicle battery charging station 270 included within the preset distance range 250.

In addition, the processor 130 may calculate a second driving route including a route 230 from the electric vehicle 210 to the selected electric vehicle battery charging station 270 and a route 240 from the selected electric vehicle battery charging station 270 to the destination 280 by including the location of the selected electric vehicle battery charging station 270 in the first driving route 220.

In addition, the processor 130 may calculate a second transportation time by adding up a transportation time required for the route 230 from the electric vehicle 210 to the selected electric vehicle battery charging station 270 and a transportation time required for the route 240 from the selected electric vehicle battery charging station 270 to the destination 280, and in most cases, the transportation time required for the driving route in which the location of the electric vehicle battery charging station 270 is included may increase.

In addition, the processor 130 may predict a remaining battery capacity of the electric vehicle battery after reaching the destination 280 by way of the electric vehicle battery charging station 270 based on the driving routes 230 and 240 including the location of the electric vehicle battery charging station 270, the increased transportation time, and the information on the electric vehicle battery, and provide the same.

In the description of FIG. 2A given above, when the electric vehicle 210 used for private driving drives to the destination 280 or when the electric vehicle 210 used for transportation driving drives to the destination 280 to load luggage or pick up people, if a remaining battery capacity after reaching the destination 280 is less than the preset remaining battery capacity limit, the electric vehicle battery charging station 270 included in the preset distance range 250 based on the calculated driving route 220 and having the smallest increase in the transportation time may be selected and included in the driving route 220 to calculate new driving routes 230 and 240.

Meanwhile, in a state in which the electric vehicle 210 used for transportation is driving, while carrying luggage or people, if the remaining battery capacity after reaching the destination 280 is less than the preset remaining battery capacity limit, the electric vehicle 210 cannot stop by an electric vehicle battery charging station during driving to lose time realistically, and thus, an electric vehicle battery charging station should be searched in the destination 280 after the load is taken down or a person gets off at the destination 280.

Accordingly, if the remaining battery capacity of the electric vehicle battery predicted in real time is less than the preset remaining battery capacity limit, the processor 130 may select an electric vehicle battery charging station based on whether the vehicle is within a preset distance range based on the destination and charging information of the electric vehicle, and include a location of the selected electric vehicle battery charging station in the driving route.

Here, the charging information of the electric vehicle may include information on at least one of a type of electric vehicle, a type of charging terminal, a charging rate, and a charging time.

Referring to FIG. 2B, when the electric vehicle 210 used for transportation selects the destination 280 while carrying luggage or people, the processor 130 may calculate the driving route 220 to the destination 280 and a transportation time based on transportation data to the destination 280, that is, hourly data to the destination 280 based on actual driving records, road information, and the information on the destination 280.

In addition, when a remaining battery capacity of the electric vehicle battery predicted in real time after the electric vehicle 210 used for transportation reaches the destination 280 after the lapse of the driving route 220 and the transportation time is less than the preset remaining battery capacity limit, the processor 130 may select the electric vehicle battery charging station 270 based on whether an electric vehicle battery charging station is within the preset distance range 250 based on the destination 280 and charging information of the electric vehicle.

Specifically, the processor 130 may select an electric vehicle battery charging station 270 matched to the information regarding a type of transportation electric vehicle 210, a type of charging terminal, and a charging rate and a charging time set by the driver, among a plurality of electric vehicle battery charging stations located within the preset distance range 250 based on the destination 280.

In addition, when an electric vehicle battery charging station matched to the information regarding the type of the corresponding transportation electric vehicle 210, the type of charging terminal, and the charging rate and charging time set by the driver, and the like, does not exist among the plurality of electric vehicle battery charging stations located within the preset distance range 250 based on the destination 280, the processor 130 may select an electric vehicle battery charging station matched to the charging information of the corresponding transportation electric vehicle and located at the closest distance, among the plurality of electric vehicle battery charging stations located outside the preset distance range 250.

For example, when the destination 280 is selected after loading luggage, the processor 130 may calculate the driving route 220 to the destination 280 and a remaining battery capacity of the electric vehicle battery upon reaching the destination 280 after the elapse of the transportation time. If the calculated remaining battery capacity of the electric vehicle battery is calculated to be less than the preset remaining battery capacity limit, for example, 30%, the processor 130 may previously select the electric vehicle battery charging station 270 which exists within the preset distance range 250 based on the destination 280 after reaching the destination 280 and is matched to the charging information of the corresponding transportation electric vehicle 210 and includes the selected electric vehicle battery charging station 270 in the driving route 220.

That is, rather than considering only the driving route 220 to the destination 280 and the transportation time, the processor 230 may calculate the driving route to the selected electric vehicle battery charging station 270 after reaching the destination 280 and the transportation time, and finally guide the electric vehicle 210 so that the battery of the transportation electric vehicle 210 to be maintained up to the electric vehicle battery charging station 270.

In addition, if another destination is added before reaching the destination 280, the processor 130 may calculate and predict a driving route including the electric vehicle battery charging station 270 selected after reaching the destination 280 and the other added destination and a transportation time.

Through this, the transportation electric vehicle 210 may receive guidance on the electric vehicle battery charging station matched to the charging information without deviating from the driving route and transportation time during the process of carrying luggage or carrying people, thereby relieving anxiety about battery charging.

Meanwhile, the processor 130 may divide the calculated driving route into a first section in which the remaining battery capacity of the electric vehicle battery is greater than the preset remaining battery capacity limit and a second section in which the remaining battery capacity of the electric vehicle battery is less than the preset remaining battery capacity limit, and select an electric vehicle battery charging station in the first section.

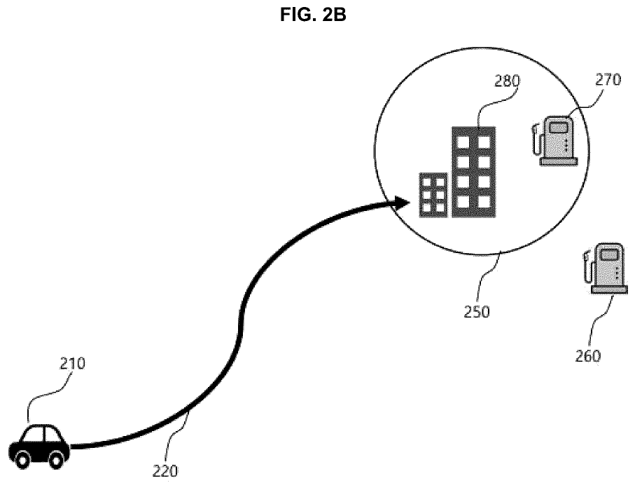

FIG. 3 is a diagram illustrating a process of selecting an electric vehicle battery charging station for each section according to a remaining battery capacity of an electric vehicle battery according to an embodiment of the present disclosure.

Referring to FIG. 3, the remaining battery capacity of the electric vehicle battery predicted by the processor 130 may be less than the preset remaining battery capacity limit while an electric vehicle 310 is driving, or may be less than the preset remaining battery capacity limit after driving.

FIG. 3 is a case in which the remaining battery capacity of the electric vehicle battery is less than the preset remaining battery capacity limit while the electric vehicle 310 is driving. In this case, the processor 130 divides the calculated driving route into a first section 320 in which the remaining battery capacity of the electric vehicle battery is greater than the preset remaining battery capacity limit and a second section 330 in which the remaining battery capacity of the electric vehicle battery is less than the preset remaining battery capacity limit, and in particular, the processor 130 selects an electric vehicle battery charging station 360 within the first section 320.

That is, the processor 130 predicts the real-time remaining battery capacity while the electric vehicle 310 is driving, and in order to charge the electric vehicle battery in advance before the remaining battery capacity falls below the preset remaining battery capacity limit, the processor 130 may search for and select the electric vehicle battery charging station 360 within a preset range in the section 320 in which the remaining battery capacity is greater than the preset remaining battery capacity limit.

Through this, the processor 130 may constantly maintain the remaining battery capacity of the electric vehicle battery not to fall below the preset remaining battery capacity limit while the electric vehicle 310 is driving.

Meanwhile, the processor 130 may generate and transmit a warning signal if the remaining battery capacity of the electric vehicle battery falls below the preset remaining battery capacity limit. For example, when the preset remaining battery capacity limit is 30%, if the remaining battery capacity of the electric vehicle battery predicted in real time after reaching the destination is calculated to be less than 30% or if the remaining battery capacity of the electric vehicle battery falls below the preset remaining battery capacity limit, the processor 130 may generate and transmit a warning signal.

Such a warning signal may include information on a driving to empty, a location of the nearest electric vehicle battery charging station, or simple warning signs.

Meanwhile, the communication unit 120 according to an embodiment of the present disclosure may receive information on a load amount.

For example, information on a load amount of transportation goods loaded in a space inside the vehicle or loaded inside the vehicle may be collected through a pressure sensor installed inside the electric vehicle or a camera capable of recognizing objects, and the communication unit 120 may receive information on the load amount from the electric vehicle.

In addition, the processor 130 may calculate an increase/decrease rate of the load amount based on the information on the load amount, correct the driving route, transportation time, and information on the electric vehicle battery based on the calculated increase/decrease rate of the load amount, and calculate a remaining battery capacity of the electric vehicle battery based on the corrected driving route, transportation time, and information on the electric vehicle battery.

The consumption amount of electric vehicle battery increases as the load amount on the electric vehicle increases and decreases as the load amount decreases, so the weight of luggage or people carried in the electric vehicle is important in calculating the consumption amount of the electric vehicle battery or predicting the remaining battery capacity.

Accordingly, the processor 130 calculates a changed increase/decrease rate regarding whether the load amount increases or decreases based on the information on the load amount, and corrects the driving route, transportation time, and the information on the electric vehicle battery changeable according to the changed increase/decrease rate.

For example, if the load amount of the electric vehicle increases and a previously calculated driving route includes hills, the driving route may be changed to include flat ground rather than hills, the transportation time may also increase, and the consumption amount of the electric vehicle battery may also increase.

In addition, the processor 130 may predict that the remaining battery capacity of the electric vehicle battery is reduced compared to before, based on the driving route changed to include flat ground, increased transportation time, and increased consumption amount of the electric vehicle battery.

In this manner, when the load amount changes, variables for predicting the remaining battery capacity of the electric vehicle battery are also bound to change, so the processor 130 predicts the remaining battery capacity of the electric vehicle battery again based on the changed variables.

In particular, the processor 130 may divide the calculated driving route into a section before the change in the load amount and a section after the change in the load amount, calculate a driving route and a transportation time in the section before the change in the load amount and a driving route and a transportation time in the section after the change in the load amount, and predict a remaining battery capacity of the electric vehicle battery based on the calculated driving route and transportation time in the section before the change in the load amount and the calculated driving route and transportation time in the section after the change in the load amount and the information on the electric vehicle battery in each of the sections before/after the change in the load amount.

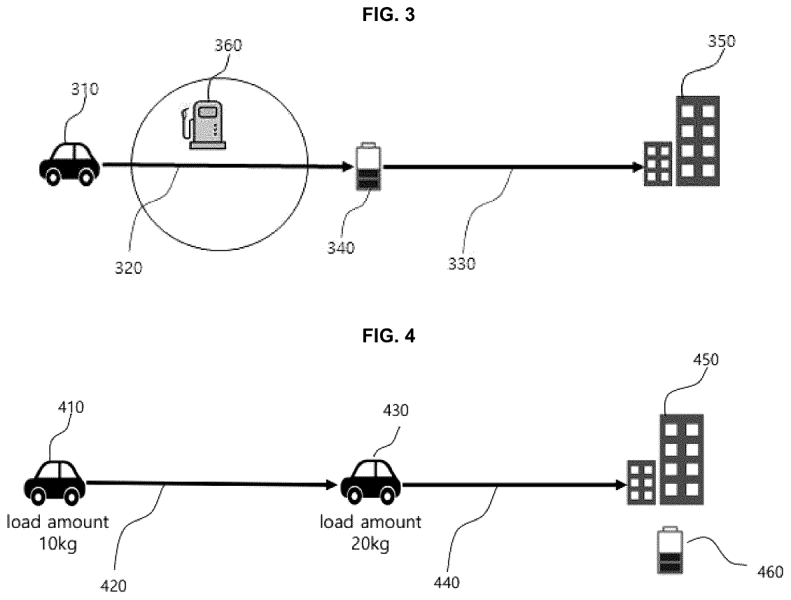

FIG. 4 is a diagram illustrating a process of predicting a remaining battery capacity of an electric vehicle battery for each section according to the increase or decrease in the load amount according to an embodiment of the present disclosure.

Referring to FIG. 4, a driving route of an electric vehicle 410 to a destination 450 is divided into a first section 420 in which the electric vehicle 410 travels with a load amount of 10 kg and a second section 440 in which an electric vehicle 430 has a load amount increased to 20 kg by loading 10 kg more midway, and a remaining capacity 460 of the electric vehicle battery after reaching the destination 450 due to the increase in the load amount is illustrated.

Specifically, the processor 130 may calculate the driving route and transportation time in the section before the change in the load amount, that is, the first section 420 in which the load amount is 10 kg, as a driving route including hills and a transportation time of 10 minutes.

In addition, the processor 130 may calculate a driving path and a transportation time in the section after the change in load, in which a driving route includes flat ground and the transportation time may be calculated as 20 minutes which has relatively increased, compared to the driving route leading to the destination 450 in a state in which the existing load amount is 10 kg,

In addition, the processor 130 may separately calculate information on the electric vehicle battery in each of the sections before/after the change in the load amount, that is, a consumption amount of the electric vehicle battery in the first section 420 in which the vehicle drives with the load amount of 10 kg and a consumption amount of the electric vehicle battery in the second section 440 in which the vehicle drives with the load amount of 20 kg, and the consumption amount of the electric vehicle battery in the second section 440 increases proportionally compared to the consumption amount of the electric vehicle battery in the first section 420.

In addition, the processor 130 may predict the remaining capacity 460 of the electric vehicle battery after reaching the destination 450 based on the driving route including a hill calculated in the first section 420 in which the electric vehicle travels with the load amount of 10 kg and the transportation time of 10 minutes, the driving route including flat ground calculated in the second section 440 in which the electric vehicle travels with the load amount of 20 kg and the transportation time of 20 minutes, the consumption amount of the electric vehicle battery in the first section 420, and the consumption amount of the electric vehicle battery in the second section 440 in which the electric vehicle travels with the load amount of 20 kg.

In this manner, when the load amount changes, the transportation time, driving route, and battery consumption may change according to the changed load amount, so the transportation time, driving route, and battery consumption amount should be calculated separately for each section in which the load amount has changed, and based on which the remaining battery capacity of the electric vehicle battery may be accurately predicted.

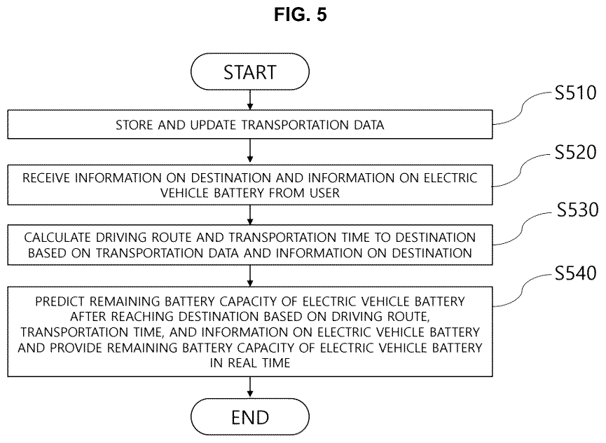

FIG. 5 is a flowchart illustrating a controlling method of a battery charge management server for an electric vehicle according to an embodiment of the present disclosure.

Referring to FIG. 5, the controlling method of a battery charge management server for an electric vehicle according to an embodiment of the present disclosure includes storing and updating transportation data (S510), receiving information on a destination and information on an electric vehicle battery from a user (S520), calculating a driving route and a transportation time to the destination based on the transportation data and the information on the destination (S530), and predicting a remaining battery capacity of the electric vehicle battery after reaching the destination based on the driving route, transportation time, and information on the electric vehicle battery and providing the predicted remaining battery capacity of the electric vehicle battery in real time (S540).

Here, the transportation data includes regional and hourly data and road information based on actual driving records, the regional and hourly data may include hourly driving record data and driving time data within a region, and the road information may include road condition information and traffic information within a region.

In addition, the information on the electric vehicle battery may include at least one of a real-time remaining battery capacity of the electric vehicle battery, a consumption rate, a charging time, and a distance to empty.

In addition, the operation process and controlling method of the processor 130 described above may all be included in the controlling method of the battery charge management server for an electric vehicle according to an embodiment of the present disclosure.

Meanwhile, the storage unit 110 according to an embodiment of the present disclosure may include a software module for transportation linkage between a plurality of vehicles.

Specifically, the storage unit 110 may include a driving route calculation module, a transportation time calculation module, and an electric vehicle battery remaining capacity prediction module.

Specifically, the driving route calculation module may calculate a driving route to a destination based on transportation data and information on the destination, and the transportation time calculation module may calculate a transportation time to the destination based on the transportation data and the information on the destination.

In addition, the electric vehicle battery remaining capacity prediction module may predict a remaining battery capacity of the electric vehicle battery after reaching the destination based on the driving route, transportation time, and the information on the electric vehicle battery, and provide the same in real time.

As described above, a non-transitory computer-readable medium in which a program for performing electric vehicle battery charge management according to the present disclosure is stored may be provided.

The non-transitory computer-readable medium refers to a medium that stores data semi-permanently and may be read by a device, rather than a medium that stores data for a short period of time, such as registers, caches, and memories. Specifically, the various applications or programs described above may be stored and provided on non-transitory readable mediums, such as CD, DVD, hard disk, Blu-ray disk, USB, memory card, ROM, etc.

In addition, although a bus is not shown in the block diagram described above for the battery charge management server 100 for an electric vehicle, communication between each component in the battery charge management server 100 for an electric vehicle may be performed through the bus. In addition, each device may further include a processor, such as a CPU or microprocessor that performs various operations described above.

Although embodiments of the present disclosure have been illustrated and described hereinabove, the present disclosure is not limited to the above-mentioned specific embodiments, but may be variously modified by those skilled in the art to which the present disclosure pertains without departing from the scope and spirit of the present disclosure as disclosed in the accompanying claims. These modifications should also be understood to fall within the scope of the present disclosure.

What is claimed is:

1. A battery charge management server for an electric vehicle, the battery charge management server comprising:
a storage unit configured to store and update transportation data;
a communication unit configured to receive information on a destination and information on an electric vehicle battery from a user; and
a processor configured to calculate a driving route and a transportation time to the destination based on the transportation data and the information on the destination, predict a remaining battery capacity of the electric vehicle battery after reaching the destination based on the driving route, the transportation time, and the information on the electric vehicle battery, and providing the predicted remaining battery capacity.

2. The battery charge management server of claim 1, wherein
the transportation data includes regional and hourly data and road information based on actual driving records,
the regional and hourly data include hourly driving record data and driving time data within a region, and
the road information includes road condition information and traffic information within a region.

3. The battery charge management server of claim 2, wherein the information on the electric vehicle battery includes at least one of the real-time remaining battery capacity of the electric vehicle battery, consumption rate, a charging time, and a distance to empty.

4. The battery charge management server of claim 3, wherein, when the remaining battery capacity of the electric vehicle battery predicted in real time is less than a preset remaining battery capacity limit, the processor selects an electric vehicle battery charging station based on whether the vehicle is within a preset distance range based on the calculated driving route and an increase in the transportation time and includes a location of the selected electric vehicle battery charging station in the driving route.

5. The battery charge management server of claim 3, wherein, when the remaining battery capacity of the electric vehicle battery predicted in real time is less than a preset remaining battery capacity limit, the processor selects an electric vehicle battery charging station based on whether the vehicle is within a preset distance range based on the destination and charging information of the electric vehicle and includes a location of the selected electric vehicle battery charging station in the driving route.

6. The battery charge management server of claim 5, wherein the charging information of the electric vehicle includes information on at least one of a type of the electric vehicle, a type of a charging terminal, a charging rate, and a charging time.

7. The battery charge management server of claim 4, wherein the processor divides the calculated driving route into a first section in which the remaining battery capacity of the electric vehicle battery is greater than the preset remaining battery capacity limit and a second section in which the remaining battery capacity of the electric vehicle battery is less than the preset remaining battery capacity limit and selects the electric vehicle battery charging station within the first section.

8. The battery charge management server of claim 7, wherein, when the remaining battery capacity of the electric vehicle battery is less than the preset remaining battery capacity limit, the processor generates and transmits a warning signal.

9. The battery charge management server of claim 8, wherein the communication unit receives information on a load amount, and
the processor calculates an increase/decrease rate of the load amount based on the information on the load amount, corrects the driving route, the transportation time, and the information on the electric vehicle battery based on the calculated increase/decrease rate of the load amount, and predicts a remaining battery capacity of the electric vehicle battery based on the corrected driving route, the transportation time, and the information on the electric vehicle battery.

10. The battery charge management server of claim 9, wherein the processor divides the calculated driving route into a section before a change in the load amount and a section after the change in the load amount, calculates a driving route and a transportation time in the section before the change in the load amount and a driving route and a transportation time in the section after the change in the load amount, and predicts the remaining battery capacity of the electric vehicle battery based on the calculated driving route and transportation time in the section before the change in the load amount, the calculated driving route and transportation time in the section after the change in the load amount, and the information on the electric vehicle battery in each of the sections before/after the change in the load amount.

11. A controlling method of a battery charge management server for an electric vehicle, the controlling method comprising:
storing and updating transportation data;
receiving information on a destination and information on an electric vehicle battery from a user;
calculating a driving route and a transportation time to the destination based on the transportation data and the information on the destination; and
predicting a remaining battery capacity of an electric vehicle battery after reaching the destination based on the driving route, the transportation time, and the information on the electric vehicle battery, and providing the predicted remaining battery capacity of the electric vehicle battery.
